(19) United States
(12) Patent Application Publication
(10) Pub. No.: US 2026/0336446 A1
(43) Pub. Date: Oct. 29, 2026

(54) Charging Robot for Charging an Electrical Energy Store of a Vehicle

(71) Applicant: Bayerische Motoren Werke Aktiengesellschaft, Muenchen (DE)

(72) Inventors: Alexander EWALD, Muenchen (DE); Bernhard HOESS, Muenchen (DE); Jan PILARSKI, Muenchen (DE)

(21) Appl. No.: 19/124,373

(22) PCT Filed: Sep. 6, 2023
(86) PCT No.: PCT/EP2023/074457

§ 371 Date: Apr. 25, 2025

(30) Foreign Application Priority Data
Oct. 28, 2022 (DE) 10 2022 128 692.4

(51) Int. Cl. B60L 53/35; B60L 53/16; B60L 53/60

(52) U.S. Cl. CPC B60L 53/35; B60L 53/16; B60L 53/60

(57) ABSTRACT

Described is a charging robot for charging an electrical energy store of a vehicle. The charging robot comprises a base unit which has an interface module of a first type designed to form a plug-in connection with an interface module of a charging station of a complementary second type, and a robot unit which has a robot interface module designed to form a plug-in connection with a vehicle interface module of a vehicle. The charging robot further comprises a connecting element which is designed to electrically conductively connect the interface module of the base unit to the robot interface module of the robot unit.

### BACKGROUND AND SUMMARY

The invention relates to a charging robot for charging an electrical energy store of a (motor) vehicle.

Vehicles having an electric drive (in particular electric vehicles or plug-in hybrid vehicles) comprise electrical energy stores (e.g. batteries) which, by means of a charging apparatus of the vehicle, can be connected to a charging station and charged. For the charging of electrical energy stores, various conductive i.e. hard-wired technologies exist. In “AC charging”, or alternating current charging, the charging device, which converts direct current (also described as DC) for charging the electrical energy store, is located in the vehicle. On a charging cable between the charging station, in particular the wall box, and the vehicle, an AC current or alternating current is transmitted. In “DC charging”, or direct current charging, a DC current or direct current is transmitted on the charging cable. In many cases, DC charging is also described as “rapid charging”, as the charging power associated with DC charging typically exceeds the charging power associated with AC charging.

The manual plugging-in of the charging plug of a charging station into the charging socket of a vehicle can be perceived by a user as inconvenient. Consequently, a charging robot can be employed, which is designed to automatically establish the plug-in connection between the charging plug and the charging socket.

The present document addresses the technical issue of providing a particularly efficient charging robot for charging the electrical energy store of a vehicle.

This object is fulfilled by the independent claim. Advantageous embodiments and implementations are described inter alia in the dependent claims. It is hereby observed that additional features of a patent claim which is dependent upon an independent patent claim, in the absence of the features of the independent patent claim, or in combination with only a subset of the features of the independent patent claim, can constitute a standalone invention which is independent of the combination of all the features of the independent patent claim, and which can form the subject matter of an independent claim, a divisional application, or a subsequent application. The same applies, in an equivalent manner, to the technical instruction described in the description, which can constitute an invention which is independent of the features of the independent patent claims.

According to one aspect, a charging robot is described for charging an electrical energy store of a (motor) vehicle (in particular of a passenger car, a heavy goods vehicle, a bus or a motorcycle). The charging robot comprises a base unit, which has an interface module of a first type which is designed to form a plug-in connection with an interface module of a charging station (in particular of a wall box) of a complementary second type. The base unit can be configured for connecting to a wall (e.g. in proximity to the charging station, in particular to the wall box).

An interface module of the first type can comprise or constitute a charging socket or charging contact tube, in particular a charging socket or charging contact tube according to IEC 62196-3. An interface module of the second type can comprise or constitute a charging plug, in particular a charging plug according to IEC 62196-3. It is hereby observed that aspects described in the present document are applicable to arbitrary forms of interface modules, in particular to arbitrary standards.

The charging robot further comprises a robot unit, having a robot interface module which is designed to form an electrically conductive connection, in particular a plug-in connection, with a vehicle interface module of a vehicle. In a preferred example, the robot interface module is an interface module of the second type. Moreover, in a preferred example, the vehicle interface module is an interface module of the first type.

The robot unit can be configured to move itself and/or the robot interface module of the robot unit over a ground surface, in order to position the robot interface module of the robot unit relative to the vehicle interface module of a vehicle (and thus to automatically establish an electrically conductive connection, in particular a plug-in connection, between the two interface modules). To this end, the robot unit can comprise one or more sensors, which are configured to capture sensor data with respect to the environment of the robot unit, and/or one or more actuators (e.g. electrical motors), which are configured to move the robot unit and/or the robot interface module of the robot unit.

The charging robot further comprises a connecting element (in particular, a connecting cable) which is configured to connect the interface module of the base unit to the robot interface module in an electrically conductive manner (in particular by means of individual electrical conductors).

The interface module of the base unit and the robot interface module of the robot unit can respectively comprise multiple power contacts for the transmission of electrical energy for charging the electrical energy store of a vehicle. The connecting element of the charging robot can comprise multiple conductors, each of which is configured to mutually connect the corresponding power contacts of the interface module of the base unit and of the robot interface module of the robot unit in an electrically conductive manner, in a respective one-to-one arrangement.

Alternatively or additionally, the interface module of the base unit and the robot interface module of the robot unit can respectively comprise one or more communication contacts for the transmission of data for controlling a charging process. The connecting element of the charging robot can comprise one or more conductors, each of which is configured to mutually connect the one or more corresponding communication contacts of the interface module of the base unit and of the robot interface module of the robot unit in an electrically conductive manner, in a respective one-to-one arrangement.

In particular, the connecting element of the charging robot can be configured such that, by means of the connecting element, a charging process of the electrical energy store of a vehicle which is coupled to the robot interface module of the robot unit can be controlled by a charging station which is coupled to the interface module of the base unit. A charging station which is separate from the charging robot can thus be employed to control a charging process which is executed by means of the charging robot (e.g. according to a specific standard, for example IEC 62196 or IEC 61851).

The connecting element of the charging robot can further be configured such that electrical energy for charging the electrical energy store can be supplied by the charging station via the connecting element. The conversion of electrical energy for a charging process (in particular an AC/DC conversion) which is executed by means of the charging robot can thus be effected in a charging station which is separate from the charging robot. It is thus not necessary for any charging device to be provided within the charging robot.

In particular, the charging robot can be configured, by means of a charging station which is coupled to the base unit, to execute a DC charging process and/or an AC charging process of the electrical energy store of a vehicle which is coupled to the robot unit.

A charging robot is thus described which is configured to employ a separate charging station, in particular a wall box, to control and/or to supply electrical energy for charging process which are executed by means of the charging robot. A particularly efficient charging robot can be provided accordingly.

The charging robot can comprise a locking mechanism for locking the plug-in connection between the interface module of the base unit and the interface module of a charging station. The charging robot can further comprise an unlocking element (e.g. an unlocking button and/or an unlocking sensor) which is configured to enable a user to release the locking function which is executed by the locking mechanism. By the provision of a releasable locking function, particularly secure charging processes can be executed by means of the charging robot.

The charging robot, in particular the base unit, can comprise a power supply module, which is configured to supply electrical energy for operating one or more components of the charging robot, in particular one or more sensors and/or actuators of the charging robot, from an electric power supply grid (e.g. from a 230 V grid). A reliable and efficient operation of the laboratory robot can thus be enabled.

The charging robot, in particular the base unit, can comprise a control unit, which is designed to control the charging robot for the establishment of an electrically conductive connection, in particular a plug-in connection, between the robot interface module of the robot unit and the vehicle interface module of a vehicle. Moreover, the connecting element can comprise one or more conductors for communicating with and/or for the supply of energy to one or more components, in particular one or more sensors and/or actuators, of the robot unit. A particularly reliable and efficient operation of the charging robot can thus be enabled.

It is hereby observed that methods, apparatuses and systems described in the present document can be employed both individually and in combination with other methods, apparatuses and systems which are described in the present document. Moreover, any aspects of the methods, apparatus and systems described in the present document can be mutually combined in a variety of ways. In particular, the features of the claims can be mutually combined in a variety of ways. Moreover, features indicated in brackets are to be understood as optional features.

The invention is described in greater detail hereinafter with reference to exemplary embodiments.

### BRIEF DESCRIPTION OF THE DRAWINGS

FIG. 1 shows a block diagram of an exemplary charging system;

FIG. 2 shows an exemplary assignment of contacts of a charging socket of a vehicle; and

FIG. 3 shows an exemplary charging robot.

### DETAILED DESCRIPTION OF THE DRAWINGS

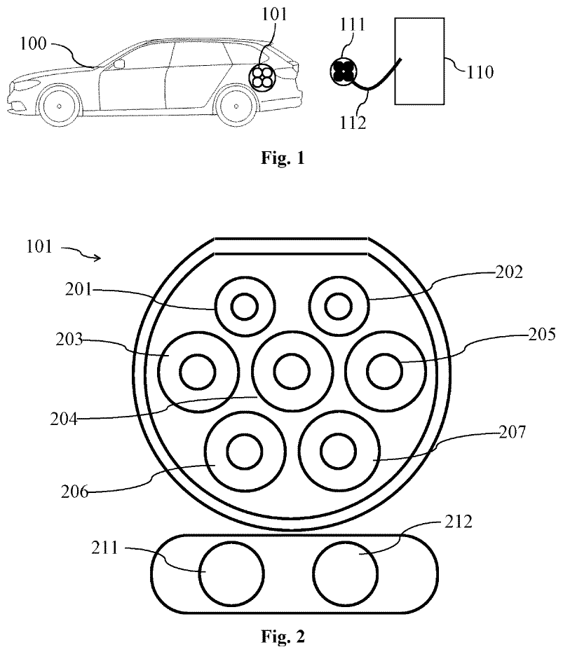

As described above, the present document addresses the provision of a particularly efficient charging robot. In this context, FIG. 1 shows a block diagram of an exemplary charging system, having a charging station 110 (e.g. a wall box) and a vehicle 100. The vehicle 100 comprises an (unrepresented) electrical energy store, which can be charged by means of electrical energy from the charging station 110. The vehicle 100 comprises a charging socket 101 (described in general as an interface module) into which a corresponding (charging) plug 111 of a charging cable 112 can be plugged. The charging socket 101 and the plug 111 typically form a plug-in system. The charging cable 112 can be permanently connected to the charging station 110 (as represented). Alternatively, the charging cable 112 can be connected to the charging station 110 by means of a plug-in connection (e.g. in the case of AC charging).

As represented in FIG. 1, the charging socket 101 is fitted to the vehicle 100. Various plug variants exist, according to IEC plug standard n° 62196-3: Combo 1, Combo 2,DC-Type 1 or DC-Type 2. FIG. 2 shows an exemplary Combo 2 charging socket 101 having a multiplicity of contacts 201, 202, 203, 204, 205, 206, 207, 211, 212. The contact 202 (also described as a pin) can be employed for the transmission of a pilot signal (and connected to a pilot conductor of the charging cable 112). The contact 201 can be employed for the transmission of a proxy signal. The contacts 201, 202 can also be described as communication contacts, as they are designed to transmit communication signals for communication between the charging station 110 and the vehicle 100 with respect to a control of the charging process. The contact 205 can be employed for the neutral conductor of an AC current, and the contact 203 can be employed for a first phase L1 of the AC current. The contact 207 can be employed for a second phase L2 of the AC current. Moreover, the contact 206 can be employed for a third phase L3 of the AC current. The contacts 203, 205, 206, 207 can be described as power contacts or AC contacts, as they are designed to transmit electric current for charging the electrical energy store of the vehicle 100. The contact 204 can provide a connection to ground. It is hereby observed that the above-mentioned assignment of contacts of a charging socket 101 is exemplary, and the other assignments are possible. The charging cable 112 comprises corresponding conductors for the contacts 201, 202, 203, 204, 205, 206, 207 (or optionally for only a proportion of the contacts 201, 202, 203, 204, 205, 206, 207).

The charging socket further comprises contacts 211, 212 for DC charging, which contacts can be employed e.g. for a negative polarity or a positive polarity of the DC current. The contacts 211, 212 can be described as DC contacts and/or as power contacts. A charging socket 110 can optionally be configured to supply electrical energy for a charging process via DC contacts 211, 212 only, or via AC contacts 203, 205, 206, 207 only.

The control unit of the charging station 110 can be designed, by means of a pulse-width modulation of the pilot signal (e.g. at a duty cycle between 7% and 97%), to communicate the (optionally maximum) current intensity or charging power which can be delivered by the charging station 110 to the vehicle 100. The pilot signal can thus oscillate at a predefined frequency (e.g. of 1 kHz) between two predefined levels.

One example of a level- and/or PWM-based communication protocol of this type is IEC standard 61851-1. This standard defines various modes, wherein mode 3 and mode 4 are particularly relevant with respect to charging on a charging station 110. In particular, mode 3 is relevant to AC charging, and mode 4 is relevant to DC charging on a charging station 110. A further exemplary standard for charging processes is IEC 62196, as described above.

It is hereby observed that the aspects described in the present document are applicable to arbitrary charging standards and/or to proprietary solutions.

The charging station 110 can be configured as a charging robot, which is configured to automatically plug the charging plug 111 into the charging socket 101 of a vehicle. To this end, the charging robot comprises a control unit which is configured to communicate with the vehicle 100 for the control of a charging process. Optionally, the charging robot further comprises an AC/DC or AC/AC converter, which is designed to supply and/or control charging power for the charging process. The provision of a charging robot of this type is associated with a relatively high complexity of hardware and software.

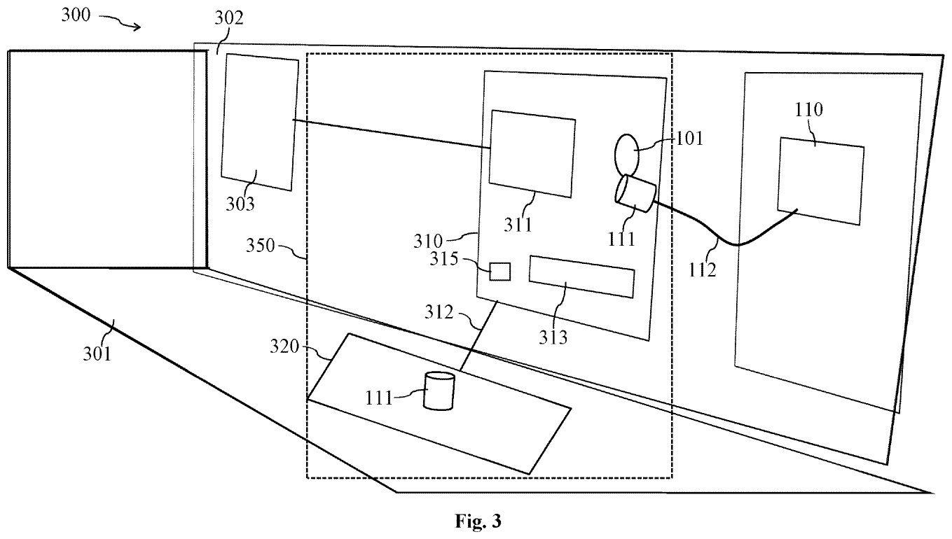

FIG. 3 shows a system 300 having a charging robot 350, which is configured to employ components of an existing charging station 110, in particular of an existing wall box, such that the charging robot 350 can be provided in a particularly efficient manner. The charging robot 350 comprises a base unit 310 which e.g. can be fastened to a wall 302. The charging robot 350 further comprises a robot unit 320, which is moveably configured, in particular for the positioning of the charging plug 111 of the charging robot 350, which is arranged on the robot unit 320, on the charging socket 101 of a vehicle 100, and for the insertion thereof into the charging socket of the vehicle 100. In the example represented in FIG. 3, the robot unit 320 is configured to move over the ground surface 301, e.g. in order to establish a plug-in connection with a charging socket 101 which is arranged on an underbody of a vehicle 100. Alternatively or additionally, the robot unit 320 can comprise a robot arm, e.g. in order to enable the positioning of the charging plug 111 to one side of the vehicle 100.

The base unit 310 of the charging robot 350 comprises a charging socket 101, into which the charging plug 111 of the charging station 110 can be plugged. This charging socket 101 is connected by means of a connecting element 312 of the base unit 310 to the charging plug 111 of the robot unit 320. The individual contacts 201, 202, 203, 204, 205, 206, 207, 211, 212 of the charging socket 101 of the base unit 310 can thus be connected, in a one-to-one arrangement, to the corresponding contacts 201, 202, 203, 204, 205, 206, 207, 211, 212 of the charging plug 111 of the robot unit 320 (by means of individual conductors in the connecting element 312 in each case).

The base unit 310 can be configured to lock the plug-in connection between the charging plug 111 of the charging station 110 and the charging socket 101 of the base unit 310. An unlocking element 313 (e.g. a button and/or a sensor) can be provided on the base unit 310, which enables this locking function to be released. By the provision of a locking function, a particularly secure charging process can be enabled, as any release of the plug-in connection between the charging plug 111 of the charging station 110 and the charging socket 101 of the base unit 310, in response to a load, can reliably be prevented.

In the example represented in FIG. 3, the robot interface module 111 of the robot unit 320 is configured as a charging plug (corresponding to the charging plug 111 of the charging station 110). Moreover, the vehicle interface module 101 of a vehicle 100 is configured as a charging socket. It is hereby observed that, for the electrically conductive (plug-in) connection between the robot unit 320 and a vehicle 100, a different type of connection can also be employed. However, the application of the same type of connection as that employed between the charging station 110 and the base unit 310 is advantageous, if it is intended that, as a vehicle interface module 101 for connecting to the robot interface module 111 of the robot unit 320, the charging socket of the vehicle 100 is to be employed, which is also employed for directly connecting to a charging station 110.

The base unit 310 can comprise an energy supply module 311, e.g. having an AC/DC converter, which is designed to source electrical energy from a power supply grid, e.g. from a 230 V grid, for operating the charging robot 350. The energy supply module 311 can be connected e.g. (for example by means of a plug-in connection) to a power supply grid (for example to a plug socket 303 of the power supply grid). The energy supply module 311 can comprise a voltage converter. However, electrical energy for charging the electrical energy store of a vehicle 100 is not supplied from the energy supply module 311, but from the charging socket 101 of the base unit 310 of the charging station 110.

The charging robot 350, in particular the base unit 310, can comprise a control unit 315, which is designed to control the robot unit 320 for the automatic establishment of the plug-in connection between the charging plug 111 of the robot unit 320 and the charging socket 101 of a vehicle 100. To this end, on the charging robot 350, in particular on the robot unit 320, one or more (unrepresented) sensors are provided, which are configured to capture the environment of the robot unit 320. The connecting element 312 between the base unit 310 and the robot unit 320 can comprise one or more additional conductors (additionally to the conductors of the charging cable 112 of the charging station 110), e.g. in order to supply one or more components of the robot unit 320 with electrical energy and/or in order to control the one or more components of the robot unit 320.

Accordingly, one or more functions can be provided in a base unit 310 of a charging robot 350:
a standard charging interface 101 for a further utilization of an AC or DC wall box 110 which, optionally, is already installed, and can simultaneously be employed with one or more further electrically powered vehicles 100 (e.g. a BEV, or battery electric vehicle, or a PHEV, or plug-in hybrid electric vehicle), which are not equipped with a charging robot apparatus in the vehicle 100;
a voltage converter (e.g. from 230 volts to a low voltage) for the continuous supply of a voltage to the electrical components of the charging robot 350 (e.g. as an element of the energy supply module 311);
a temperature sensor (for monitoring the charging robot 350);
a plug locking function (for the enhanced security of a charging process).

By means of the measures described in the present document, a particularly efficient charging robot 350 can be provided.

The present invention is not limited to the exemplary embodiments illustrated. In particular, it should be observed that the description and the figures are only intended to serve as an exemplary illustration of the methods, apparatuses and systems proposed.

1-11. (canceled)

12. A charging robot for charging an electrical energy store of a vehicle, wherein the charging robot comprises:
a base unit which has an interface module of a first type which is designed to form a plug-in connection with an interface module of a charging station of a complementary second type;
a robot unit, having a robot interface module which is designed to form an electrically conductive connection with a vehicle interface module of a vehicle; and
a connecting element, which is configured to connect the interface module of the base unit to the robot interface module of the robot unit in an electrically conductive manner such that, by means of the connecting element:
a charging process of the electrical energy store of a vehicle which is coupled to the robot interface module of the robot unit can be controlled by a charging station which is coupled to the interface module of the base unit; and
electrical energy for charging the electrical energy store can be supplied by the charging station.

13. The charging robot according to claim 12, wherein:
the interface module of the base unit and the robot interface module of the robot unit respectively comprise multiple power contacts for the transmission of electrical energy for charging the electrical energy store of a vehicle; and
the connecting element of the charging robot comprises multiple conductors, each of which is configured to mutually connect the corresponding power contacts of the interface module of the base unit and of the robot interface module of the robot unit in an electrically conductive manner, in a respective one-to-one arrangement.

14. The charging robot according to claim 12, wherein:
the interface module of the base unit and the robot interface module of the robot unit respectively comprise one or more communication contacts for the transmission of data for controlling a charging process; and
the connecting element of the charging robot comprises one or more conductors, each of which is configured to mutually connect the one or more corresponding communication contacts of the interface module of the base unit and of the robot interface module of the robot unit in an electrically conductive manner, in a respective one-to-one arrangement.

15. The charging robot according to claim 12, wherein the charging robot comprises:
a locking mechanism configured to lock the plug-in connection between the interface module of the base unit and the interface module of a charging station; and
an unlocking element configured to enable a user to release the locking function which is executed by the locking mechanism.

16. The charging robot according to claim 12, wherein the base unit of the charging robot comprises a power supply module configured to supply electrical energy for operating one or more components of the charging robot from an electric power supply grid.

17. The charging robot according to claim 12, wherein the base use of the charging robot comprises a control unit configured to control the charging robot for the establishment of an electrically conductive connection between the robot interface module of the robot unit and the vehicle interface module of a vehicle.

18. The charging robot according to claim 12, wherein:
the connecting element comprises one or more conductors for at least one of communicating with or supplying energy to one or more sensors and/or actuators of the robot unit (320); and
the one or more sensors are configured to capture sensor data with respect to an environment of the robot unit; and
the one or more actuators are configured to move the robot unit and/or the robot interface module of the robot unit.

19. The charging robot according to claim 12, wherein:
the robot interface module is an interface module of the second type; and
the vehicle interface module is an interface module of the first type.

20. The charging robot according to claim 12, wherein:
an interface module of the first type comprises a charging socket or charging contact tube according to IEC 62196-3; and
an interface module of the second type comprises a charging plug according to IEC 62196-3.

21. The charging robot according to claim 12, wherein at least one of:
the base unit is configured to be fastened to a wall; or
the robot unit is configured to move at least one of itself or the robot interface module of the robot unit over a ground surface, in order to position the robot interface module of the robot unit relative to the vehicle interface module of a vehicle.

22. The charging robot according to claim 12, wherein the charging robot is configured, by means of a charging station which is coupled to the base unit, to execute at least one of a DC charging process or an AC charging process of the electrical energy store of a vehicle which is coupled to the robot unit.
